(19) United States
(12) Patent Application Publication
(10) Pub. No.: US 2009/0002987 A1
(43) Pub. Date: Jan. 1, 2009

(54) Collimation Arrangement and Illumination System and Display Device Using the Same

(75) Inventors: Martijn Riemeijer, Eindhoven (NL); Georges Marie Calon, Eindhoven (NL); Edwin Van Lier, Eindhoven (NL); Lingli Wang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,067

(22) PCT Filed: Dec. 12, 2006
(86) PCT No.: PCT/IB2006/054772

§ 371 Date: Jun. 12, 2008

(30) Foreign Application Priority Data
Dec. 14, 2005 (EP) 05112087.1

(51) Int. Cl. F21V 7/00

(52) U.S. Cl. 362/247

(57) ABSTRACT

The invention relates to a collimation arrangement (1, 2, 3, 4) for collimating light emitted by at least one light emitting diode (12, 14) arranged on a planar base (16). The collimation arrangement (1, 2, 3, 4) comprising a collimator (20, 22, 24) and a set of reflective surfaces (50, 52). The collimator comprises a light-ingress window (28, 30) for admitting light emitted by the at least one light emitting diode into the collimator (20, 22, 24), a light-egress window (32, 34) for emitting the light from the collimator (20, 22, 24), and comprises a first edge surface (36), a second edge surface (38), a third edge surface (40, 42, 44) and a fourth edge surface (46, 48). The collimation arrangement (1, 2, 3, 4) is arranged for guiding light emitted by the at least one light emitting diode (12, 14) in a direction of the third and fourth edge surfaces (40, 42, 44, 46, 48) towards the light-egress window (32) via total internal reflection and is arranged for guiding light emitted by the at least one light emitting diode (12, 14) in the direction of the first and second edge surfaces (36, 38) via the reflective surfaces (50, 52). This results in a collimation arrangement of which the width (w) can be easily reduced.

The invention relates to collimation arrangement for collimating light emitted by at least one light emitting diode.

The invention further relates to an illumination system and a display device.

Collimators for collimating light emitted by light emitting diodes are known per se. They are used inter alia to reduce the angular distribution of the light emitted by a light emitting diode (further also indicated as LED) and guide the emitted light towards, for example, a backlighting system of a display device. Collimators are also used to enhance the uniformity of the emitted light and, in case a plurality of light emitting diodes are used which emit different colors, the collimator enhances color mixing of the light emitted by the individual light emitting diodes. Preferably, reflection of light from the walls of the collimator to collimate the light is based on total internal reflection to minimize loss of light.

Such a collimator is known from the US patent application US 2003/0076034. In this patent application a collimator is disclosed which comprises multiple colored LED chips arranged in a linear array on a single elongated base. The known collimator is integrally mounted over the LED chips on the base. The array of colored LED chips may, for example, comprise conventional green, red and blue LED chips which produce, when mixed, white light. The known collimator is configured as rectangular, horn-like member having a planar top wall that extends parallel to the elongated base. The known collimator is typically manufactured from plastic as a single solid member with a cavity for the LED chips. The cavity surrounds the LED chips and is typically filled with a transparent silicone material. The light emitted by the LED chips is reflected from the side walls of the known collimator by total internal reflection, collimating and mixing the emitted light. In an embodiment of the known collimator as disclosed in the cited patent application, the known collimator has been optimized for a 6 millimeter thick backlight waveguide. In such application the walls of the cavity surrounding the LED chips must be shaped to obtain highly collimated light from the LED chips.

A trend in optical systems such as backlighting systems is a further miniaturization of the systems. These optical systems often comprise collimators. A drawback of the known collimators is that the dimensions of the collimators are too large.

It is an object of the invention to provide a collimation arrangement having reduced dimensions.

According to a first aspect of the invention the object is achieved with a collimation arrangement for collimating light emitted by at least one light emitting diode arranged on a planar base, the collimation arrangement comprising a collimator comprising: a symmetry plane substantially perpendicular to the planar base, a light-ingress window for admitting light emitted by the at least one light emitting diode into the collimator, a light-egress window for emitting the light from the collimator, a first edge surface facing a second edge surface, the first and second edge surfaces being planar surfaces arranged substantially parallel on opposite sides of the symmetry plane and extending between the light-ingress window and the light-egress window, and a third edge surface facing a fourth edge surface, the third and fourth edge surfaces being non-planar surfaces confined between the light-ingress window, the light-egress window and the first and second edge surfaces, and being shaped to guide light emitted parallel to the symmetry plane via total internal reflection towards the light-egress window, the collimation arrangement further comprising a set of reflective surfaces arranged between the planar base and the first and second edge surfaces for reflecting light emitted by the at least one light emitting diode towards the reflective surfaces into the collimator.

The effect of the measures according to the invention is that the collimation arrangement guides light which is emitted by the at least one light emitting diode in the direction of the third and fourth edge surface towards the light-egress window via total internal reflection and guides light which is emitted by the at least one light emitting diode in the direction of the first and second edge surface via the reflective surfaces. The first and second edge surfaces are planar surfaces. The distance between the first and second edge surfaces typically determines the width of the collimator. In the known collimator the light emitting diode is arranged in a cavity which is confined by the planar base and the light-ingress window. The cavity of a known collimator typically comprises cavity walls which are part of the collimator and are formed between the light-ingress window and edge surfaces of the collimator. Reducing the dimensions of the known collimator without changing the dimensions of the cavity, for example, reducing the distance between two opposite edge surfaces, will result in thinner cavity walls in the direction of the two opposite edge surfaces. At some distance between the two opposing edge surfaces, the cavity walls will become very fragile and the cavity wall can no longer be shaped properly to enable collimation of the light emitted by the light emitting diode. In the collimation arrangement as claimed in the current patent application the collimation arrangement comprises a collimator and reflecting surfaces. The at least one light emitting diode is arranged in a cavity of the collimator. The cavity is confined by cavity walls in the direction of the third and fourth edge surface and is confined by the reflective surfaces in the direction of the first and second edge surface. By replacing the cavity walls in the direction of the first and second edge surfaces by the reflective surfaces which are not part of the collimator, the distance between the first and second edge surface can be reduced, thus reducing the width of the collimation arrangement, without having fragile cavity walls or without having cavity walls which cannot be shaped properly to enable collimation. This results in a collimation arrangement of which the dimensions can be easily reduced.

The difference between reflection using total internal reflection and reflection from a reflective surface is that total internal reflection is a loss-less reflection whereas reflection from a reflective surface typically results in some loss of light. Total internal reflection typically occurs at a boundary from an optically dense medium to an optically less dense medium. When the angle of incidence being the angle at which the incident light impinges on the boundary is larger than a critical angle, all light impinging on the boundary will be reflected back into the optically dense medium (the angle of incidence of a light beam is usually defined between a normal at the boundary and the impinging light beam). In contrast, reflection from a reflective surface, for example, a metal coating, typically implies loss of light due to absorption of some of the incident light by the reflective surface.

An additional benefit of the claimed subject matter is that the use of reflective surfaces arranged between the planar base and the first and second edge surfaces increases the manufacturability of the collimation arrangement compared to the known collimators. In the known collimators, the at least one light emitting diode is arranged in a cavity surrounding the at least one light emitting diode. By reducing the width of the known collimator the walls of the cavity will become very thin which results in a collimator which can be damaged easily both during manufacturing and assembly. The inventors have realized that by replacing the walls of the cavity in the direction of the first and second edge surfaces by reflective surfaces arranged between the planar base and the first and second edge surfaces, thin and fragile cavity walls can be omitted at the first and second edge surface. Due to the use of the reflective surfaces in the collimation arrangement according to the invention, a collimation arrangement is created of which the dimensions can be reduced while maintaining good manufacturability.

The use of reflective surfaces to collimate the light emitted by light emitting diodes is, for example, disclosed in a European patent application EP 1 103 759. This document discloses the use of reflective cups surrounding light emitting diodes for collimation purposes. In contrast, the collimation arrangement of the current invention shows a unique combination of collimation via reflective surfaces, and guidance or collimation via total internal reflection. Due to this combination of reflection from reflective surfaces and reflection via total internal reflection, the dimensions of the collimation arrangement according to the invention can be reduced, while the loss of light due to reflection is limited.

In an embodiment of the collimation arrangement, the reflective surfaces are shaped to obtain an angular distribution inside the collimator of the light reflected from the reflective surfaces which enables confinement of the light reflected from the reflective surfaces between the first edge surface and the second edge surface via total internal reflection. A benefit of this embodiment is that after the reflection from the reflective surfaces the light is substantially loss-less confined between the first and second edge surface. The required shape of the reflective surfaces can be determined using known ray-tracing programs.

In an embodiment of the collimation arrangement, the reflective surfaces are arranged on the planar base. A benefit of this embodiment is that the reflective surfaces can be mechanically mounted on the planar base next to the at least one light emitting diode, which simplifies the assembly of the collimation arrangement according to the invention.

In a preferred embodiment of the collimation arrangement, the reflective surfaces are part of the planar base. For example, both the reflective surfaces and the planar base are injection molded in a single shape. A benefit of this embodiment is that the position of the reflective surfaces with respect to the planar base is always well defined which further simplifies the assembly of the collimation arrangement. A further benefit of this embodiment is that the cost of the production of the planar base together with the reflective surfaces can be reduced.

These and other aspects of the invention are apparent from and will be elucidated with reference to the embodiments described hereinafter.

### IN THE DRAWINGS

FIGS. 1A, 1B and 1C show cross-sections of a collimation arrangement according to the invention,

FIGS. 2A and 2B show cross-sections of a further collimation arrangement according to the invention,

FIG. 3 shows a cross-section of yet another collimation arrangement according to the invention,

FIG. 4 shows an illumination system according to the invention, and

FIG. 5 shows a display device according to the invention.

The figures are purely diagrammatic and not drawn to scale. Particularly for clarity, some dimensions are exaggerated strongly. Similar components in the figures are denoted by the same reference numerals as much as possible.

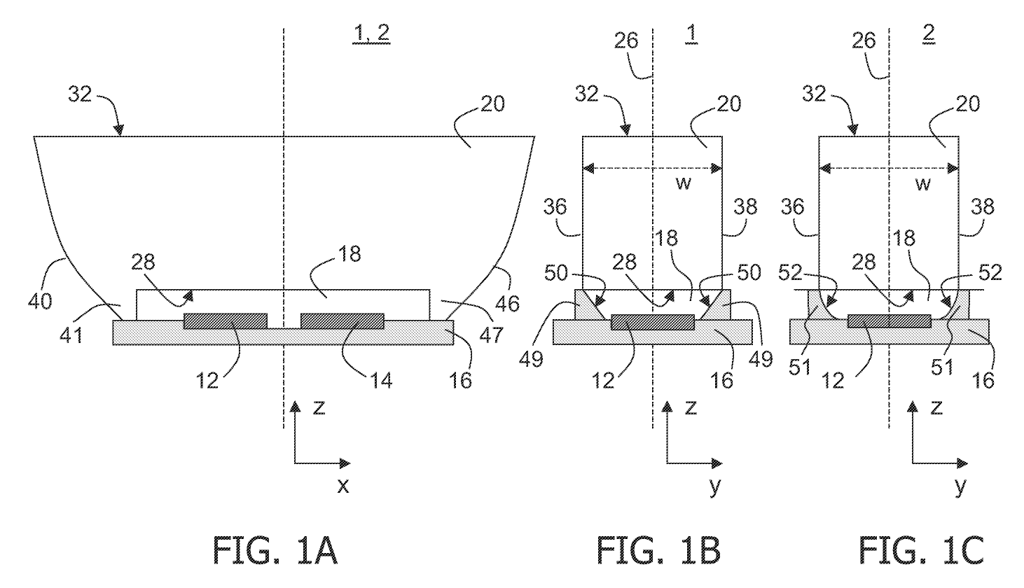

FIGS. 1A, 1B and 1C show cross-sections of a collimation arrangement 1, 2 according to the invention. The cross-section of FIG. 1A coincides with a symmetry plane 26 as indicated in FIGS. 1B and 1C. In FIG. 1A a planar base 16 is shown having at least one light emitting diode 12, 14 for emitting light into the collimation arrangement 1, 2. The collimation arrangement 1, 2 comprises a collimator 20 and reflective surfaces 50, 52. The collimator 20 usually is constituted of transparent material such as transparent plastics, glass or quartz. The collimator 20 comprises a light-ingress window 28 via which the light emitted by the at least one light emitting diode 12, 14 is admitted into the collimator 20. The collimator 20 further comprises a light-egress window 32 via which the collimated light is emitted by the collimator 20. The collimator 20 comprises a first edge surface 36 (see FIGS. 1B and 1C), a second edge surface 38 (see FIGS. 1B and 1C), a third edge surface 40 and a fourth edge surface 46. The first edge surface 36 and the second edge surface 38 are parallel planar surfaces arranged on opposite sides of the symmetry plane 26 and extend between the light-ingress window 28 and the light-egress window 32. The third edge surface 40 is a non-planar edge surface facing the non-planar fourth edge surface 46. The shape of the third edge surface 40 and the fourth edge surface 46 are chosen such that light emitted parallel to the symmetry plane 26 is guided to the light-egress window 32 via total internal reflection. The required shape of the third edge surface 40 and fourth edge surface 46 can be determined via well known ray-tracing programs. The collimation arrangement further comprises reflective surfaces 50, 52 arranged between the planar base 16 and the first edge surface 36 and between the planar base 16 and the second edge surface 38, on opposite sides of the symmetry plane 26. In FIG. 1B the reflective surfaces 50 are simple planar surfaces reflecting the light emitted by the at least one light emitting diode 12, 14 towards the reflective surface 50 into the collimator 20. In FIG. 1C the reflective surfaces 52 are shaped such that the light emitted by the at least one light emitting diode 12, 14 towards the reflective surface 52 is reflected into the collimator 20 such that the light is confined inside the collimator 20 between the first edge surface 36 and the second edge surface 38 via total internal reflection. The required shape, again, can be determined using well known ray-tracing programs.

The collimator 20 further comprises a cavity 18 which is confined by the light-ingress window 28, the planar base 16, and the reflective surfaces 50, 52. In the known collimators the cavity is confined by a light-ingress window and the planar base. The walls of the cavity are constituted by the collimator. The thickness of the cavity walls in the known collimator is determined by the distance between the light-ingress window and the edge surfaces of the known collimator. When the width of the known collimator is reduced, for example, by reducing the distance between two opposite edge surface, the walls of the cavity in the direction of the two opposite edge surface typically becomes very thin and fragile and may easily be damaged during manufacturing of the known collimator or during assembly of the known collimator with the light emitting diode. In the collimation arrangement 1, 2 according to the invention the cavity 18 is confined in the direction of the third edge surface 40 and the fourth edge surface 46 by cavity walls 41, 47 constituted by the collimator and in the direction of the first edge surface 36 and the second edge surface 38 the cavity 18 is confined by reflective surfaces 50, 52. To reduce the width w of the collimation arrangement 1, 2 according to the invention via reducing the distance between the first edge surface 36 and the second edge surface 38 while maintaining the same cavity 18 dimensions simply a shift of the reflective surfaces 50, 52 is required. There will be no thin and fragile cavity 18 walls and thus no reduction in the manufacturability of the collimator 20 in the collimation arrangement 1, 2.

FIG. 1B shows an embodiment of the collimation arrangement 1 in which the reflective surfaces 50 are simple planar surfaces reflecting light emitted by the at least one light emitting diode 12, 14 into the collimator 20. Because simple planar surfaces are used for reflecting the light into the collimator 20, not all light reflected from the reflective surfaces 50 will be confined between the first edge surface 36 and the second edge surface 38 via total internal reflection. Therefore, in the embodiment shown in FIG. 1B light may ‘leak’ from the first edge surface 36 and the second edge surface 38 causing loss of light.

FIG. 1C shows an embodiment of the collimation arrangement 2 in which the reflective surfaces 52 are shaped surfaces reflecting light emitted by the at least one light emitting diode 12, 14 into the collimator 20 such that the light is confined inside the collimator 20 between the first edge surface 36 and the second edge surface 38 via total internal reflection. Due to the shape of the reflective surfaces 52 shown in FIG. 1C substantially all light reflected from the reflective surfaces 52 will be confined between the first edge surface 36 and the second edge surface 38 via total internal reflection and thus substantially no light will ‘leak’ from the first edge surface 36 or the second edge surface 38. The required shape of the reflective surfaces 52 can be determined using well known ray-tracing programs.

In order to have the reflective surfaces 50, 52 on opposite sides of the symmetry plane 26 next to the at least one light emitting diode 12, 14, the planar base 16 comprises surface shaping elements 49, 51. These surface shaping elements 49, 51 may be individual elements arranged at the planar base 16 during assembly of the collimation arrangement 1, 2 or may be an integral part of the planar base 16.

In an embodiment of the collimation arrangement 1, 2 in which the at least one light emitting diode 12, 14 is an array of light emitting diodes emitting a plurality of different primary colors, the collimation arrangement 1, 2 beneficially is used as light mixing chamber. The array of light emitting diodes 12, 14 may, for example, emit the primary colors Red, Green and Blue, which are, at least partially, mixed inside the collimation arrangement 1, 2.

The collimation arrangement 1, 2 as shown in FIGS. 1A, 1B and 1C enables a strong reduction in the width w of the collimator 20. In an embodiment of the collimation arrangement 1, 2 according to the invention the width w is less than 5 millimeters and preferably less than 2,5 millimeters. The collimation in the direction of the first edge surface 36 and the second edge surface 38 is achieved using the reflective surfaces 50, 52.

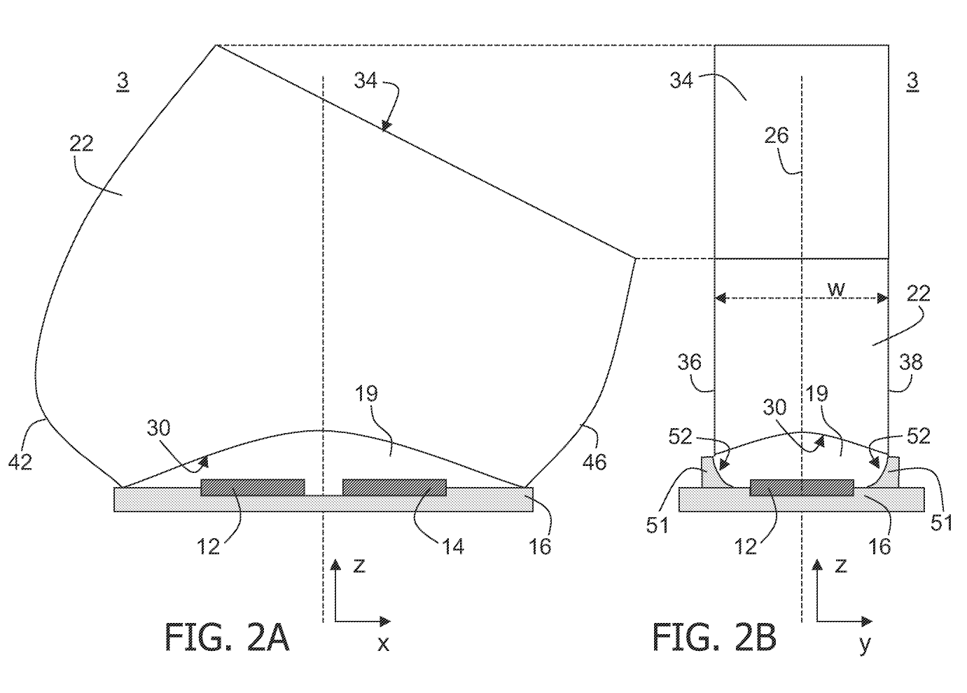

FIGS. 2A and 2B show cross-sections of a further collimation arrangement 3 according to the invention. The collimation arrangement 3 shown in FIG. 2A comprises a collimator 22 having a different third edge surface 42 compared to the collimation arrangement 1, 2 shown in FIG. 1A. Because of this adapted third edge surface 42 the collimator 22 does not emit light substantially perpendicular to the planar surface 16 (as is shown in the embodiment of the collimation arrangement 1, 2 of FIG. 1A), but emits light substantially in a direction perpendicular to the light-egress window 34. The shape of the adapted third edge surface 42 is still chosen that the light emitted by the at least one light emitting diode 12, 14 parallel to the symmetry plane 26 will be collimated via total internal reflection and finally directed into a direction substantially perpendicular to the light-egress window 34.

In an alternative embodiment of the collimation arrangement 3 according to the invention, the total internal reflection at the third edge surface 42 and the fourth edge surface 46 may be obtained by combining a shape of the light-ingress window 30 with the shape of the third edge surface 42 and the fourth edge surface 46 as can be seen in FIGS. 2A and 2B. Refraction at the light-ingress window 30 due to a difference of an optical density of a filling material in the cavity 19 and of the transparent collimator 22 together with the shape of the light-ingress window 30, the third edge surface 42 and the fourth edge surface 46 will ensure that the light emitted by the at least one light emitting diode 12, 14 in a direction parallel to the symmetry plane 26 will be collimated via total internal reflection. The required shapes of the light-ingress window 30 together with the third edge surface 42 and the fourth edge surface 46 may be determined using well known ray-tracing programs.

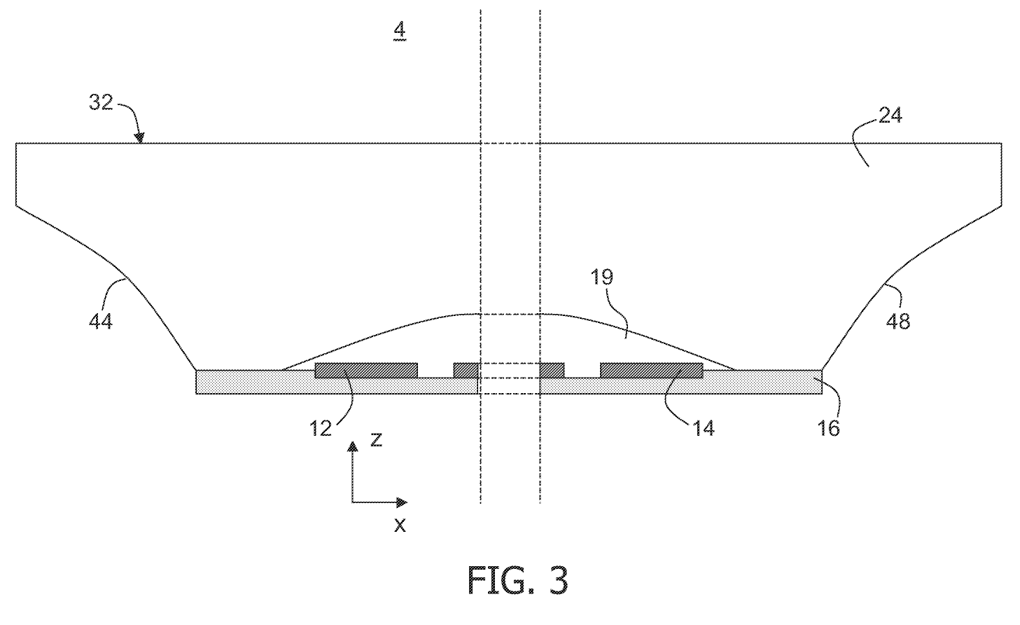

FIG. 3 shows a cross-section of yet another collimation arrangement 4 according to the invention. The reflective surfaces (not shown) are still present, arranged on opposite sides of the symmetry plane 26 next to the at least one light emitting diode 12, 14 and collimating the light emitted by the at least one light emitting diode into the collimator 24. However, light emitted parallel to the symmetry plane 26 in the direction of the third edge surface 44 and of the fourth edge surface 48 will not be collimated by the collimator 24, but will be guided towards the light-egress window 32 while substantially maintaining a broad angular distribution of the light emitted by the at least one light emitting diode 12, 14. The shapes of the third edge surface 44 and the fourth edge surface 48 are still chosen such that the light which impinges on the third edge surface 44 or the fourth edge surface 48 is guided towards the light-egress window 32 via total internal reflection. This embodiment of the collimation arrangement 3 is especially beneficial as light mixing chamber for an array of light emitting diodes 12, 14 in which the light emitting diodes emit light of different primary color. The collimation arrangement 4 will, at least partially, mix the light emitted by the array of light emitting diodes 12, 14.

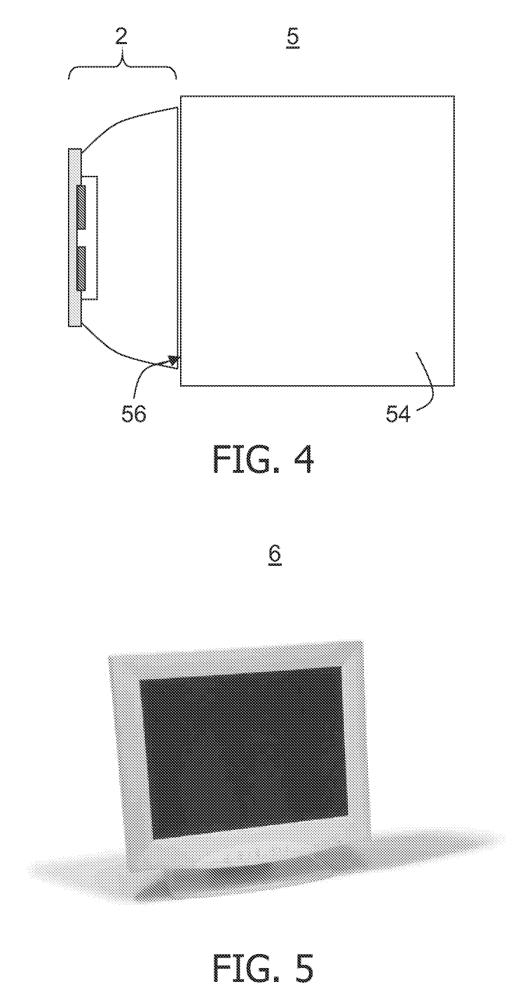

FIG. 4 shows an illumination system 5 according to the invention. The illumination system 5 comprises a collimation arrangement 2 as shown in FIGS. 1A and 1C which is coupled to a light guide 54. The collimation arrangement 2 emits light via the light-egress window 32 into the entrance window (56) of the light guide 54. The light guide 54 typically comprises light out-coupling elements (not shown) for coupling out the light in a required direction.

FIG. 5 shows a display device 6 according to the invention. The display device 6, for example, is a transmissive display device 6 having, for example, a backlighting system and an array of liquid crystal cells constituting the display. The backlighting system, for example comprises the illumination system 5 as shown in FIG. 4. By selecting the transmissivity of the individual liquid crystal cells an image can be formed on the display device 6 which will be illuminated by the backlighting system.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. A collimation arrangement (1, 2, 3, 4) for collimating light emitted by at least one light emitting diode (12, 14) arranged on a planar base (16), the collimation arrangement (1, 2, 3, 4) comprising a collimator (20, 22, 24) comprising:
a symmetry plane (26) substantially perpendicular to the planar base (16),
a light-ingress window (28, 30) for admitting light emitted by the at least one light emitting diode into the collimator (20, 22, 24),
a light-egress window (32, 34) for emitting the light from the collimator (20, 22, 24),
a first edge surface (36) facing a second edge surface (38), the first and second edge surfaces (36, 38) being planar surfaces arranged substantially parallel on opposite sides of the symmetry plane (26) and extending between the light-ingress window (28, 30) and the light-egress window (32, 34), and
a third edge surface (40, 42, 44) facing a fourth edge surface (46, 48), the third and fourth edge surfaces (40, 42, 44, 46, 48) being non-planar surfaces confined between the light-ingress window (28, 30), the light-egress window (32, 34) and the first and second edge surfaces (36, 38), and being shaped to guide light emitted parallel to the symmetry plane (26) via total internal reflection towards the light-egress window (32, 34),
the collimation arrangement (1, 2, 3, 4) further comprising a set of reflective surfaces (50, 52) arranged between the planar base (16) and the first and second edge surfaces (36, 38) for reflecting light emitted by the at least one light emitting diode (12, 14) towards the reflective surfaces (50, 52) into the collimator (20, 22, 24).

2. Collimation arrangement (1, 2, 3, 4) as claimed in claim 1, wherein the reflective surfaces (52) are shaped to obtain an angular distribution inside the collimator (20, 22, 24) of the light reflected from the reflective surfaces (52) for confining the light reflected from the reflective surfaces (52) between the first edge surface (36) and the second edge surface (38) via total internal reflection.

3. Collimation arrangement (1, 2, 3, 4) as claimed in claim 1, wherein the third and fourth edge surface (40, 42, 46) being shaped to collimate light emitted parallel to the symmetry plane (26) via total internal reflection.

4. Collimation arrangement (1, 2, 3, 4) as claimed in claim 1, wherein the reflective surfaces (50, 52) are arranged on the planar base (16).

5. Collimation arrangement (1, 2, 3, 4) as claimed in claim 1, wherein the reflective surfaces (50, 52) are part of the planar base (16).

6. Collimation arrangement (1, 2, 3, 4) as claimed in claim 1, wherein the collimation arrangement (1, 2, 3, 4) comprises an array of light emitting diodes (12, 14) arranged symmetrically with respect to the symmetry plane (26).

7. Collimation arrangement (1, 2, 3, 4) as claimed in claim 6, wherein the array of light emitting diodes (12, 14) comprises light emitting diodes emitting different primary colors.

8. Collimation arrangement (1, 2, 3, 4) as claimed in claim 1, wherein the collimator width (w) is less than 5 millimeters and preferably less than 2,5 millimeters.

9. Illumination system (5) having a collimation arrangement (1, 2, 3, 4) as claimed in claim 1.

10. Display device (6) having a collimation arrangement (1, 2, 3, 4) as claimed in claim 1.
